(19) United States
(12) Patent Application Publication
(10) Pub. No.: US 2018/0325078 A1
(43) Pub. Date: Nov. 15, 2018

(54) Pet bed cover

(71) Applicant: Theresa Ann Seese, Marietta, GA (US)

(72) Inventor: Theresa Ann Seese, Marietta, GA (US)

(21) Appl. No.: 15/592,462

(22) Filed: May 11, 2017

(51) Int. Cl. A01K 1/035

(52) U.S. Cl. CPC A01K 1/0353

(57) ABSTRACT

Disclosed are various embodiments of a cover for a pet bed including a sheet for protecting the bedding from being soiled by a pet, such as from hairs, urine, feces, vomit and other animal debris. The protecting component is a bed covering fabricated with a backing of waterproof and soil proof flexible material.

### BACKGROUND

The present invention relates generally to pet items, and more specifically to methods, systems and apparatuses relating to pet bed covers. Pet beds are available in a variety of shapes, sizes and configurations. Since pet beds inevitably become soiled with use, various different approaches have been developed to maintain cleanliness.

In some types of pet beds, the material upon which the pet rests is non-absorbent and smooth to shed moisture, soil and hair. Materials commonly used for this purpose include various synthetic materials and various natural materials that have been chemically treated to render them resistant to moisture, dirt and hair. Unfortunately, synthetic materials may not be comfortable for some pets or may not have the appearance, texture, wear or other properties desired by the pet owner. Additionally, materials that have been chemically treated may irritate some pets.

Another approach is to place cushioning material into a washable case, which may be provided with a zipper or other closure mechanism to keep the cushioning material in place. Unfortunately, such cases are awkward to remove for laundering and to install after laundering, and have limited aesthetic appeal.

Domesticated animals and particularly indoor pets are more content if they have a comfortable bed. Without a covering, the bed can become soiled with dirt, pet dander, and other animal debris. Typical pet beds are difficult to wash, not only for their bulky shape, but also for the comforting material within the bed.

Therefore, there is a need to provide a pet bed with a cover, which encloses the bed, and provides an animal debris layer to the bed that can easily be washed. Further, such a layer can provide waterproofing so liquids do not enter the bed, but remain on the easily washable and changeable sheet.

### BRIEF SUMMARY

Embodiments of the present disclosure include various apparatuses, methods, and mechanisms related to an improved cover for a pet bed including a sheet for protecting the bedding from being soiled by a pet, such as from hairs, urine, feces, vomit and other animal debris. The protecting component is a bed covering fabricated with a backing of waterproof and soil-proof flexible material.

A primary object of the present disclosure is to provide an improved pet sheet bed cover that will overcome the shortcomings of prior art devices.

Another object is to provide an improved pet sheet bed cover that will protect bedding from being soiled by a pet, such as from hairs, urine, feces, vomit and similar materials.

An additional object is to provide an improved pet sheet bed cover that will fit over the existing bedding, so as to blend into the decor of the bed and the bedroom.

A further object is to provide an improved pet sheet bed cover that is simple and easy to use.

A still further object is to provide an improved pet sheet bed cover that is economical in cost to manufacture.

Other aspects and features of embodiments of the present invention will become apparent to those of ordinary skill in the art, upon reviewing the following detailed description in conjunction with the accompanying figures.

### BRIEF DESCRIPTION OF THE FIGURES

FIG. 1 is pet bed sheet according to one embodiment of the present disclosure.

### DETAILED DESCRIPTION OF PREFERRED EMBODIMENTS

Although preferred embodiments of the invention are explained in detail, it is to be understood that other embodiments are contemplated. Accordingly, it is not intended that the disclosure is limited in its scope to the details of construction and arrangement of components set forth in the following description or illustrated in the drawings. Included in the disclosure are other embodiments and other ways of practicing the various embodiments of the disclosure. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The present disclosure preferably includes various apparatuses, methods, and mechanisms directed to a fitted sheet cover for pet beds. The sheets are preferably 100% machine wash and dryable, with fitted elastic seams. The sheet protects a pet's bed from wear and tear and keeps the bed (and your pet) clean.

Embodiments of the present disclosure remove the need to utilize chemical sprays or harsh soaps to clean the bedding. Just change the present sheets, and the pet bed remains clean and fresh.

The sheet can be a fitted sheet with elastic edges to maintain hold onto the bed, or can utilize zippers, or other securing means.

The sheet can be formed from cotton, flannel, and other comfortable materials that can have varying thickness and degrees of wicking.

The sheets can be provided in different colors, prints and sizes to fit all pet bed sizes and shapes.

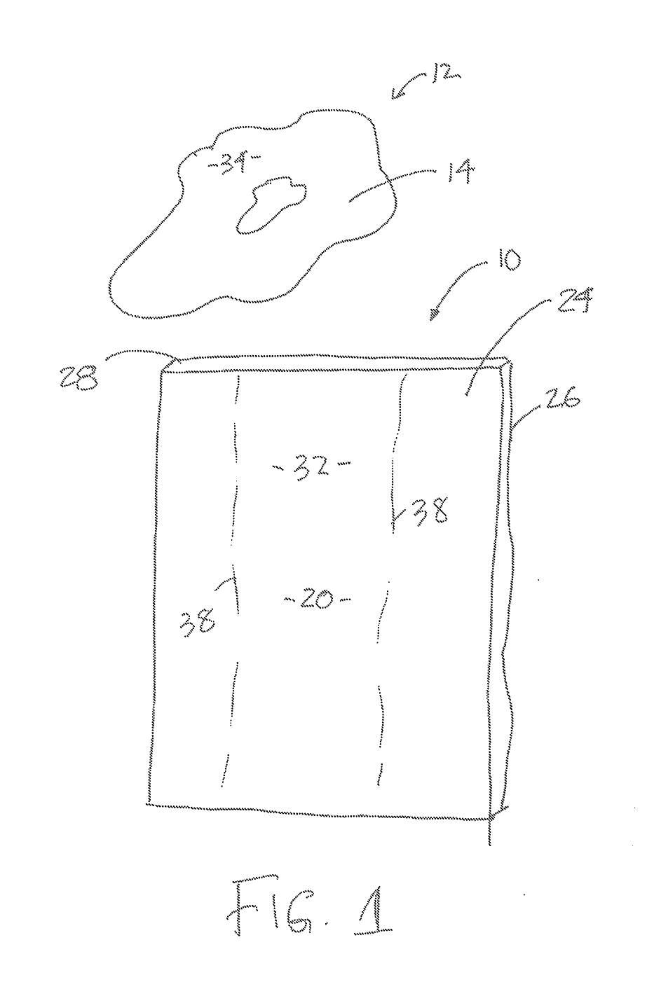

Turning now to the FIGURE, FIG. 1 illustrates an improved pet sheet bed cover 10 for a bed 12 having bedding 14 comprising a component 20 for protecting the bedding 14 from being soiled by a pet, such as from hairs, urine, feces, vomit and similar materials. In a preferred embodiment, the protecting component 20 is a bed covering 24, fabricated out of waterproof and soil proof flexible material 26, or the covering 24 has a layer 26 of waterproof material.

The waterproof and soil proof flexible material 26 can be a layer of high density foam 28.

The bed covering 24 can include a panel 32 to fit upon and cover the top surface 34 of the bedding 14. The bed covering 24 may further contain a pair of side panels 36, each extending from one side of the panel 32, so as to hang down along the sides of the pet bed while covering the bed 12. The panels 36 are integral with the panel 32 along a fold line 38 there between.

The bed covering 24 can be produced in various sizes and styles to fit most standard beds 12. The bed covering 24 can be produced in different color and print configurations, so as to be used in conjunction with other matching bedding, while blending into the decor of the bed 12 and/or the room that the bed 12 is located in.

The bedding 14 can be in the form of a bed cover, a quilted comforter, a blanket, a quilt, a bedspread, a light coverlet and a bed sheet. The bedding 14 can also include a pillow top for additional comfort, while still providing a waterproof layer for protection of the bed.

Numerous characteristics and advantages have been set forth in the foregoing description, together with details of structure and function. While the embodiments of the present disclosure have been described in several forms, it will be apparent to those skilled in the art that many modifications, additions, and deletions, especially in matters of shape, size, and arrangement of parts, can be made therein without departing from the spirit and scope of the invention and its equivalents as set forth in the following claims.

Therefore, other modifications or embodiments as may be suggested by the teachings herein are particularly reserved as they fall within the breadth and scope of the claims here appended.

What is claimed is:

1. A pet bed system as described herein.

2. The system according to claim 1, including each and every novel feature or combination of features disclosed herein.

3. A process for covering a pet bed as described herein.

4. The process of claim 3, including each and every novel feature or combination of features disclosed herein.

5. A pet bed cover as described herein.

6. The pet bed cover of claim 5, including each and every novel feature or combination of features disclosed herein.
